(19) United States
(12) Patent Application Publication
(10) Pub. No.: US 2024/0324019 A1
(43) Pub. Date: Sep. 26, 2024

(54) USER EQUIPMENT (UE) UPLINK TRANSMISSION FOR RANDOM ACCESS CHANNEL (RACH) PROCEDURES IN HALF DUPLEX FREQUENCY DIVISION DUPLEX (HD-FDD) MODE

(71) Applicant: QUALCOMM Incorporated, San Diego, CA (US)

(72) Inventors: Jing LEI, San Diego (CA); Linhai HE, San Diego, CA (US); Peter GAAL, San Diego, CA (US); Chao WEI, Beijing (CN); Muhammad Nazmul ISLAM, Littleton, MA (US); Tingfang JI, San Diego, CA (US); Prashant SHARMA, San Marcos, CA (US); Murali MENON, Acton, MA (US)

(21) Appl. No.: 18/578,170

(22) PCT Filed: Aug. 6, 2021
(86) PCT No.: PCT/CN2021/111156

§ 371 Date: Jan. 10, 2024

(51) Int. Cl. H04W 74/0833; H04L 5/14

(52) U.S. Cl. CPC H04W 74/0833; H04L 5/14

(57) ABSTRACT

In a user equipment (UE) of a wireless communication network, the UE configured to operate in half duplex frequency division duplexing (HD-FDD) mode in the network the UE configures for one or more conditions under which the UE will transmit under HD-FDD mode in uplink (UL) to the network and not receive in downlink (DL) from the network during a Random Access Channel (RACH) procedure. The UE determines whether the configured one or more conditions obtain for a particular RACH procedure. Upon determining that the configured one or more conditions obtain for the particular RACH procedure, the UE transmits under HD-FDD mode in UL during the particular RACH procedure in accordance with the configured one or more conditions.

### CROSS-REFERENCE TO RELATED APPLICATION(S)

This application is a 35 U.S.C. § 371 National Phase Application of PCT Application No. PCT/CN2021/111156 filed Aug. 6, 2021, entitled “USER EQUIPMENT (UE) UPLINK TRANSMISSION FOR RANDOM ACCESS CHANNEL (RACH) PROCEDURES IN HALF DUPLEX FREQUENCY DIVISION DUPLEX (HD-FDD) MODE,” which is assigned to the assignee hereof and hereby incorporated by reference herein in the entirety.

### BACKGROUND

### Technical Field

The present disclosure relates generally to communication systems, and more particularly in some examples, to uplink (UL) transmission control in user equipment (UE) of a wireless communication network operating in half duplex frequency division duplex (HD-FDD) mode during random access channel (RACH) procedures.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems. These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

The technology disclosed herein includes method, apparatus, and computer-readable media including instructions for wireless communication. In such technology, in a user equipment (UE) of a wireless communication network, the UE configured to operate in half duplex frequency division duplexing (HD-FDD) mode in the network the UE configures for one or more conditions under which the UE will transmit under HD-FDD mode in uplink (UL) to the network and not receive in downlink (DL) from the network during a Random Access Channel (RACH) procedure. The UE determines whether the configured one or more conditions obtain for a particular RACH procedure. Upon determining that the configured one or more conditions obtain for the particular RACH procedure, the UE transmits under HD-FDD in UL during the particular RACH procedure in accordance with the configured one or more conditions.

In some examples of the technology disclosed herein, the one or more conditions include one or more of: a priority class of RACH procedure transmissions, the priority class including one or more of physical RACH (PRACH) transmissions, physical UL shared channel (PUSCH) transmissions, physical UL control channel (PUCCH) transmissions, and sounding reference signal (SRS) transmissions; and a set of one or more transmission parameters including one or more of power control parameters, coverage enhancement parameters, and beam forming parameters of the UL transmissions of the RACH procedure.

In some examples, the transmission includes at least one of a PRACH transmission, a PUSCH transmission, a PUCCH transmission, and a SRS transmission; and transmitting includes applying one or more of power control, coverage enhancement, and beamforming parameters to the transmission.

In some examples, configuring includes receiving, by the UE from the network in DL, the one or more conditions. In some such examples, receiving the one or more conditions includes receiving the one or more conditions via one or more of: one or more radio resource control (RRC) messages, one or more system information (SI) messages, and one or more medium access control-control element (MAC-CE) messages. In some examples configuring includes pre-configuring the UE with one or more of as the one or more conditions.

In some examples pre-configuring the UE with the one or more conditions includes pre-configuring a priority class and one or more transmission parameters of the RACH procedure based on one or more of handover (HO) characteristics, scheduling requests for mission critical reports, Beam Failure Recovery (BFR) characteristics, and access identities pre-defined for higher priority access classes as the one or more conditions.

In some examples, configuring includes pre-configuring the UE with the one or more conditions; receiving, by the UE from the network in DL, one or more modifications to the pre-configured one or more conditions; and reconfiguring the UE with the received one or more modifications.

In some examples, configuring includes identifying a set of one or more RACH procedure characteristics as the one or more conditions under which the UE will transmit under HD-FDD mode in UL and not receive in DL regardless of one or more DL transmission characteristics; and configuring the UE in accordance with the identified set of one or more RACH procedure characteristics. In some such examples, the set of one or more RACH procedure characteristics comprises one or more of: handover (HO) characteristics, scheduling requests for mission critical reports, Beam Failure Recovery (BFR) characteristics, and access identities pre-defined for higher priority access classes.

In some examples, configuring includes identifying a set of one or more DL transmission characteristics under which the UE will transmit during a RACH procedure under HD-FDD mode in UL and not receive in DL; and configuring the UE in accordance with the identified set of one or more DL transmission characteristics. In some such examples, the set of one or more DL transmission characteristics includes all semi-static and cell-specific DL transmissions. In some such examples, the set of one or more DL transmission characteristics includes all semi-static and cell-specific DL transmissions, except synchronization signal block (SSB) transmissions. In some such examples, the set of one or more DL transmission characteristics excludes certain synchronization signal block (SSB) transmissions as a function of one or more of radio resource management (RRM), beam failure detection (BFD), radio link monitoring (RLM), and time/frequency tracking requirements of the UE. In some such examples, the set of one or more DL transmission characteristics includes, for a given dynamic UL grant for RACH procedures, semi-static and cell-specific DL transmissions arriving at the UE after the given dynamic UL grant for RACH procedures.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating a base station and user equipment (UE) in an access network, in accordance with examples of the technology disclosed herein.

FIG. 4 is a flowchart of methods of wireless communication is shown, in accordance with examples of the technology disclosed herein.

FIG. 5 is a flowchart of methods of wireless communication is shown, in accordance with examples of the technology disclosed herein.

FIG. 6 is a flowchart of methods of wireless communication is shown, in accordance with examples of the technology disclosed herein.

FIG. 7 is a flowchart of methods of wireless communication is shown, in accordance with examples of the technology disclosed herein.

FIG. 8 is a flowchart of methods of wireless communication is shown, in accordance with examples of the technology disclosed herein.

FIG. 9 is a block diagram of a UE, in accordance with examples of the technology disclosed herein.

FIG. 10 a flowchart of methods of wireless communication is shown, in accordance with examples of the technology disclosed herein.

FIG. 11 is a block diagram of a base station, in accordance with examples of the technology disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

In 5G NR, a UE can operate in half duplex frequency division duplexing (HD-FDD) mode in communication with a base station/gNB/network (NW). In HD-FDD mode, while the base station/gNB/NW can receive (RX) and transmit (TX) at the same time in HD-FDD mode, each UE operating in HD-FDD mode can either receive or transmit at any given time. Motivations for using HD-FDD mode include cost reduction in the UE by not needing to use a duplexer for concurrent RX/TX and power savings at the UE through sequential toggling of TX phase lock loop (PLL) and RX PLL, keeping the transceiver chain in a low-power state when communication going on in the opposite direction, and lower noise figure and insertion loss.

HD-FDD mode UE operation in NR offers advantages over HD-FDD mode operation in LTE. For example, LTE Type-B HD-FDD mode requires a one subframe gap for RX-to-TX switching. NR HD-FDD mode offers a symbol-level gap for RX-to-TX switching. Type-B HD-FDD mode is mainly used in simple devices, such as IoT devices. As another example, in LTE Type-A HD-FDD mode RX-to-TX switching can only happen at the end of the last DL subframe before UL transmission begins; while in NR HD-FDD mode RX-to-TX switching can happen at any point, including in the middle of a DL slot, or at the end of a DL slot.

Potential collisions in NR HD-FDD mode include collisions between two DL transmissions, collisions between two UL transmissions, and the collisions considered herein—between DL and UL. Potential DL/UL collisions can be between: i) dynamic DL transmissions (e.g., physical DL shared channel (PDSCH), channel state information reference signal (CSI-RS)) and semi-static UL transmissions that are cell-specific or UE specific (e.g., sounding reference signal (SRS), physical UL control channel (PUCCH), cell group physical UL shared channel (CG PUSCH), and physical RACH (PRACH); ii) semi-static DL transmissions that are cell-specific or UE specific (e.g., configured CG physical DL control channel (PDCCH) (in Type 0/0A/1/2 common search space (CSS) set), signal synchronization block (SSB)/system information block (SIB), semi-persistent scheduling (SPS) PDSCH, CSI-RS, and positioning reference signal (PRS)) and dynamic UL transmissions (e.g., PUCCH, PUSCH, SRS, PDCCH, and ordered PRACH); iii) semi-static DL and semi-static UL; iv) dynamic DL and dynamic UL; v) SSB and dynamic/semi-static UL; vi) dynamic/semi-static DL and valid RACH occasions; and vii) collisions due to direction switching.

Collisions between downlink (DL) reception and uplink (UL) transmission can happen to user equipment (UE), e.g., cell phones and low power Internet-of-Things (IoT) devices, deployed on time division duplexing (TDD) bands, or performing half duplex frequency division duplexing (HD-FDD) mode operation. The collision handling rules in HD-FDD mode operation could be different from those specified for TDD in new radio (NR) releases 15 and 16 because of the differences in scheduling constraints. For TDD operation on a single component carrier (CC) neither the next generation Node B (gNB) nor the UE is able to transmit and receive simultaneously. UL/DL collisions in TDD can be addressed by the base station transmitting a slot format indicator (SFI) in DCI. However, in HD-FDD mode, the SFI is not supported and the UE is not expected to monitor the SFI in PDCCH. In HD-FDD mode operation on paired CCs, gNB is able to transmit and receive simultaneously, but UEs performing HD-FDD mode operation are not able to transmit and receive simultaneously.

The present technology applies to the collision handling rules for UEs performing HD-FDD mode operation to achieve a better tradeoff for: complexity reduction (e.g., by not requiring a duplexer) and power saving of UE, and energy/spectral efficiency improvement of network (NW). Some potential collisions to be described in the application for HD-FDD mode operation include the following cases: UL transmissions during random access channel (RACH) procedures, and semi-static and cell-specific DL transmissions during RACH.

In some aspects, when a UE performs RACH procedures in HD-FDD mode operation (whether triggered to perform RACH procedures or ordered by the NW/base station to perform RACH procedures), the UE could be in any radio resource control (RRC) state (e.g., idle/inactive/connected). UEs in HD-FDD mode operation can be HD-only UEs or full duplex (FD) capable UEs. The UE can be FDD-capable (with full duplex), but is switched to HD-FDD mode operation for power saving. The UE can be HD-only (without duplexer, incapable of FD-FDD operation). The RACH procedure can be contention-based RACH (CBRA) or contention-free RACH (CFRA). The NW can implicitly or explicitly indicate the priority class of RACH to UE. In some instances, implicit indication can be employed based on the prioritized triggers known a priori to the UE—e.g., handover optimization (HO), beam failure report (BFR), access identities pre-defined for certain services or use cases. In some instance, explicit indication can be employed based on RRC configuration system information (SI), or medium access control (MAC) control element (CE)—involving signaling by the NW/base station. In some instances, a hybrid solution based on each of the proceeding can be employed.

UL transmissions during RACH include at least Physical RACH (PRACH) triggered by higher-layer, physical downlink control channel (PDCCH) ordered PRACH/msgA, initial and reTX of {msg3, physical uplink control channel (PUCCH) carrying hybrid automatic repeat request (HARQ) feedback to msg4/msgB, msg5}. Semi-static and cell-specific DL transmissions during RACH include at least signal synchronization block (SSB), broadcast reference signals (RS) different from SSB (e.g., CSI-RS, TRS), remaining minimum system information (RMSI), other system information (OSI), msg2, msg4, msgB, GC-PDCCH transmitted in Type 0/0A/1/2 CSS sets.

In some aspects, collision handling options in HD-FDD mode operation depend on a priority class of RACH and the RACH occasion (RO) selected by the RACH procedure. For example, if a high-priority RACH procedure is triggered by higher layer or PDCCH ordering, UL transmissions associated with high-priority RACH override semi-static and cell-specific DL transmissions when collision happens. In such cases, the UE transmits on UL and skips the DL receptions colliding with the UL transmission.

As another example of such aspects, if high-priority RACH procedure is not triggered/configured and collision is expected/happens one or an appropriate combination of the following can be used: 1) UL transmissions associated with RACH can override semi-static and cell-specific DL transmissions; 2) UL transmissions associated with RACH override semi-static and cell-specific DL transmissions except a subset of DL signals/channels (e.g., SSB); SSB always overrides UL transmissions associated with RACH; 3) UL transmissions associated with RACH override semi-static and cell-specific DL transmissions except a subset of DL signals/channels (e.g. SSB); SSB processing (receiving/skipping) is up to UE implementation and/or RRM/RLM/tracking requirements of UE; 4) based on the arrival time of dynamic grant (for UL) vs semi-static and cell-specific DL signals/channels (earlier arrival is prioritized); 5) collisions can be treated by the UE as an error event, 6) collision resolution is left up to the UE implementation.

In some aspects, collision handling options in HD-FDD mode operation can be independent of a priority class of RACH. In some such aspects: 1) UL transmissions associated with RACH always override semi-static and cell-specific DL transmissions; 2) UL transmissions associated with RACH override semi-static and cell-specific DL transmissions except a subset of DL signals/channels (e.g. SSB); SSB always overrides UL transmissions associated with RACH; 3) UL transmissions associated with RACH override semi-static and cell-specific DL transmissions except a subset of DL signals/channels (e.g. SSB); SSB processing (receiving/skipping) is up to UE implementation and/or RRM/RLM/tracking requirements of UE; 4) based on the arrival time of dynamic grant (for UL) vs semi-static and cell-specific DL signals/channels (earlier arrival is prioritized); 5) collisions can be treated by UE as an error event; and 6) collision resolution is left up to UE implementation.

In aspects of the present disclosure, methods, non-transitory computer readable media, and apparatuses are provided. In some examples of the technology disclosed herein, in a user equipment (UE) of a wireless communication network, the UE configured to operate in half duplex frequency division duplexing (HD-FDD) mode in the network the UE configures for one or more conditions under which the UE will transmit under HD-FDD mode in uplink (UL) to the network and not receive in downlink (DL) from the network during a Random Access Channel (RACH) procedure. The UE determines whether the configured one or more conditions obtain for a particular RACH procedure. Upon determining that the configured one or more conditions obtain for the particular RACH procedure, the UE transmits under HD-FDD in UL during the particular RACH procedure in accordance with the configured one or more conditions.

In some examples of the technology disclosed herein, the one or more conditions include one or more of: a priority class of RACH procedure transmissions, the priority class including one or more of physical RACH (PRACH) transmissions, physical UL shared channel (PUSCH) transmissions, physical UL control channel (PUCCH) transmissions, and sounding reference signal (SRS) transmissions; and a set of one or more transmission parameters including one or more of power control parameters, coverage enhancement parameters, and beam forming parameters of the UL transmissions of the RACH procedure.

In some examples, the transmission includes at least one of a PRACH transmission, a PUSCH transmission, a PUCCH transmission, and a SRS transmission; and transmitting includes applying one or more of power control, coverage enhancement, and beamforming parameters to the transmission.

In some examples, configuring includes receiving, by the UE from the network in DL, the one or more conditions. In some such examples, receiving the one or more conditions includes receiving the one or more conditions via one or more of: one or more radio resource control (RRC) messages, one or more system information (SI) messages, and one or more medium access control-control element (MAC-CE) messages. In some examples configuring includes pre-configuring the UE with one or more of as the one or more conditions.

In some examples pre-configuring the UE with the one or more conditions includes pre-configuring a priority class and one or more transmission parameters of the RACH procedure based on one or more of handover (HO) characteristics, scheduling requests for mission critical reports, Beam Failure Recovery (BFR) characteristics, and access identities pre-defined for higher priority access classes as the one or more conditions.

In some examples, configuring includes pre-configuring the UE with the one or more conditions: receiving, by the UE from the network in DL, one or more modifications to the pre-configured one or more conditions; and reconfiguring the UE with the received one or more modifications.

In some examples, configuring includes identifying a set of one or more RACH procedure characteristics as the one or more conditions under which the UE will transmit under HD-FDD mode in UL and not receive in DL regardless of one or more DL transmission characteristics; and configuring the UE in accordance with the identified set of one or more RACH procedure characteristics. In some such examples, the set of one or more RACH procedure characteristics comprises one or more of: handover (HO) characteristics, scheduling requests for mission critical reports, Beam Failure Recovery (BFR) characteristics, and access identities pre-defined for higher priority access classes.

In some examples, configuring includes identifying a set of one or more DL transmission characteristics under which the UE will transmit during a RACH procedure under HD-FDD mode in UL and not receive in DL; and configuring the UE in accordance with the identified set of one or more DL transmission characteristics. In some such examples, the set of one or more DL transmission characteristics includes all semi-static and cell-specific DL transmissions. In some such examples, the set of one or more DL transmission characteristics includes all semi-static and cell-specific DL transmissions, except synchronization signal block (SSB) transmissions. In some such examples, the set of one or more DL transmission characteristics excludes certain synchronization signal block (SSB) transmissions as a function of one or more of radio resource management (RRM), beam failure detection (BFD), radio link monitoring (RLM), and time/frequency tracking requirements of the UE. In some such examples, the set of one or more DL transmission characteristics includes, for a given dynamic UL grant for RACH procedures, semi-static and cell-specific DL transmissions arriving at the UE after the given dynamic UL grant for RACH procedures.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

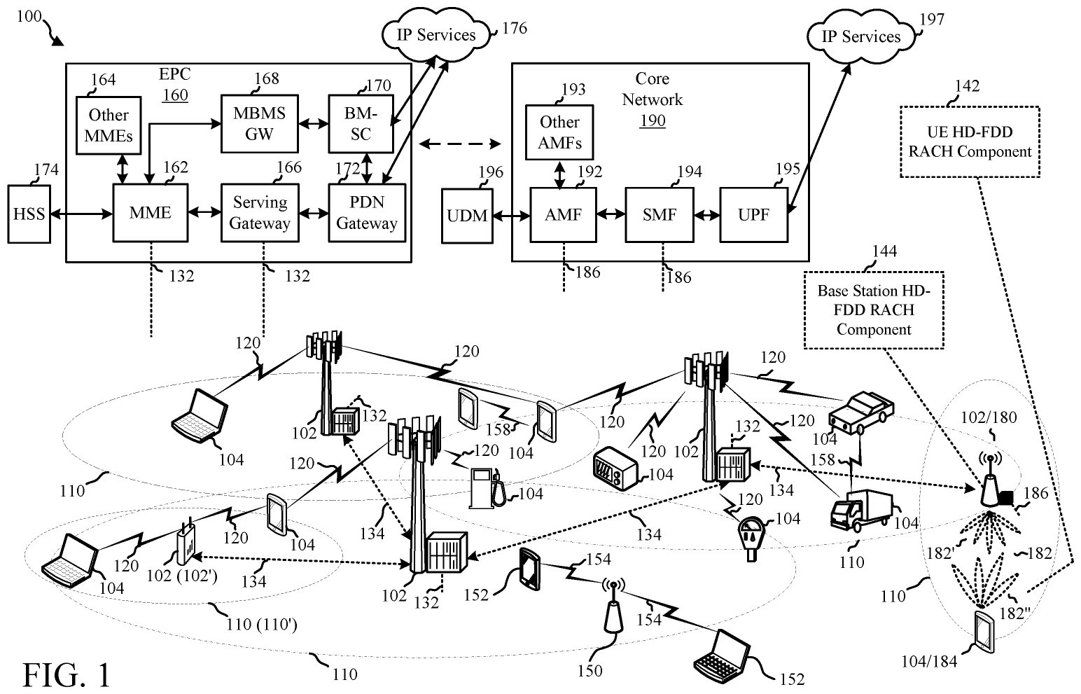

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells. The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 186. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first, second and third backhaul links 132, 186 and 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. In some examples of the technology disclosed herein, both the DL and the UL between the base station and a UE use the same set of multiple beams to transmit/receive physical channels. For example, a given set of beams can carry the multiple copies of a Physical Downlink Shared Channel (PDSCH) on the DL and can carry multiple copies of a Physical Uplink Control Channel (PUCCH) on the UL.

The communication links may be through one or more carriers. The base stations 102/UEs 104 may use spectrum up to Y MHZ (e.g., 5, 10, 15, 20, 100, 400, etc. MHZ) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the Institute of Electrical and Electronics Engineers (IEEE) 802.11 standard, LTE, or NR. The wireless communications system may further include a Wi-Fi access point (AP) 150 in communication with Wi-Fi stations (STAs) 152 via communication links 154 in a 5 GHZ unlicensed frequency spectrum. When communicating in an unlicensed frequency spectrum, the STAs 152/AP 150 may perform a clear channel assessment (CCA) prior to communicating in order to determine whether the channel is available. The small cell 102′ may operate in a licensed and/or an unlicensed frequency spectrum. When operating in an unlicensed frequency spectrum, the small cell 102′ may employ NR and use the same 5 GHZ unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include and/or be referred to as an eNB, gNodeB (gNB), or another type of base station. Some base stations, such as gNB 180 may operate in one or more frequency bands within the electromagnetic spectrum. The base station 180 and the UE 104 may each include a plurality of antennas, such as antenna elements, antenna panels, and/or antenna arrays to facilitate the beamforming.

The electromagnetic spectrum is often subdivided, based on frequency/wavelength, into various classes, bands, channels, etc. In 5G NR two initial operating bands have been identified as frequency range designations FR1 (410 MHZ-7.125 GHz) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “Sub-6 GHZ” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHZ” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming with the UE 104/184 to compensate for the path loss and short range using beams 182.

The base station 180 may transmit a beamformed signal to the UE 104/184 in one or more transmit directions 182′. The UE 104/184 may receive the beamformed signal from the base station 180 in one or more receive directions 182″. The UE 104/184 may also transmit a beamformed signal to the base station 180 in one or more transmit directions. The base station 180 may receive the beamformed signal from the UE 104 in one or more receive directions. The base station 180/UE 104/184 may perform beam training to determine the best receive and transmit directions for each of the base station 180/UE 104/184. The transmit and receive directions for the base station 180 may or may not be the same. The transmit and receive directions for the UE 104/184 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a packet-switched (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Continuing to refer to FIG. 1, in certain aspects, in a user equipment (UE) of a wireless communication network, the UE configured to operate in half duplex frequency division duplexing (HD-FDD) mode in the network, the UE configures for one or more conditions under which the UE will transmit under HD-FDD mode in uplink (UL) to the network and not receive in downlink (DL) from the network during a Random Access Channel (RACH) procedure. The UE determines whether the configured one or more conditions obtain for a particular RACH procedure. Upon determining that the configured one or more conditions obtain for the particular RACH procedure, the UE transmits under HD-FDD in UL during the particular RACH procedure in accordance with the configured one or more conditions.

In some examples of the technology disclosed herein, the one or more conditions include one or more of: a priority class of RACH procedure transmissions, the priority class including one or more of physical RACH (PRACH) transmissions, physical UL shared channel (PUSCH) transmissions, physical UL control channel (PUCCH) transmissions, and sounding reference signal (SRS) transmissions; and a set of one or more transmission parameters including one or more of power control parameters, coverage enhancement parameters, and beam forming parameters of the UL transmissions of the RACH procedure.

In some examples, the transmission includes at least one of a PRACH transmission, a PUSCH transmission, a PUCCH transmission, and a SRS transmission; and transmitting includes applying one or more of power control, coverage enhancement and beamforming parameters to the transmission.

In some examples, configuring includes receiving, by the UE from the network in DL, the one or more conditions. In some such examples, receiving the one or more conditions includes receiving the one or more conditions via one or more of: one or more radio resource control (RRC) messages, one or more system information (SI) messages, and one or more medium access control-control element (MAC-CE) messages. In some examples configuring includes pre-configuring the UE with one or more of as the one or more conditions.

In some examples pre-configuring the UE with the one or more conditions includes pre-configuring a priority class and one or more transmission parameters of the RACH procedure based on one or more of handover (HO) characteristics, scheduling requests for mission critical reports, Beam Failure Recovery (BFR) characteristics, and access identities pre-defined for higher priority access classes as the one or more conditions.

In some examples, configuring includes pre-configuring the UE with the one or more conditions: receiving, by the UE from the network in DL, one or more modifications to the pre-configured one or more conditions; and reconfiguring the UE with the received one or more modifications.

In some examples, configuring includes identifying a set of one or more RACH procedure characteristics as the one or more conditions under which the UE will transmit under HD-FDD mode in UL and not receive in DL regardless of one or more DL transmission characteristics; and configuring the UE in accordance with the identified set of one or more RACH procedure characteristics. In some such examples, the set of one or more RACH procedure characteristics comprises one or more of: handover (HO) characteristics, scheduling requests for mission critical reports, Beam Failure Recovery (BFR) characteristics, and access identities pre-defined for higher priority access classes.

In some examples, configuring includes identifying a set of one or more DL transmission characteristics under which the UE will transmit during a RACH procedure under HD-FDD mode in UL and not receive in DL; and configuring the UE in accordance with the identified set of one or more DL transmission characteristics. In some such examples, the set of one or more DL transmission characteristics includes all semi-static and cell-specific DL transmissions. In some such examples, the set of one or more DL transmission characteristics includes all semi-static and cell-specific DL transmissions, except synchronization signal block (SSB) transmissions. In some such examples, the set of one or more DL transmission characteristics excludes certain synchronization signal block (SSB) transmissions as a function of one or more of radio resource management (RRM), beam failure detection (BFD), radio link monitoring (RLM), and time/frequency tracking requirements of the UE. In some such examples, the set of one or more DL transmission characteristics includes, for a given dynamic UL grant for RACH procedures, semi-static and cell-specific DL transmissions arriving at the UE after the given dynamic UL grant for RACH procedures.

Although the following description may be focused on 5G NR, the concepts described herein may be applicable to other similar areas, such as LTE, LTE-A, CDMA, GSM, and other wireless technologies.

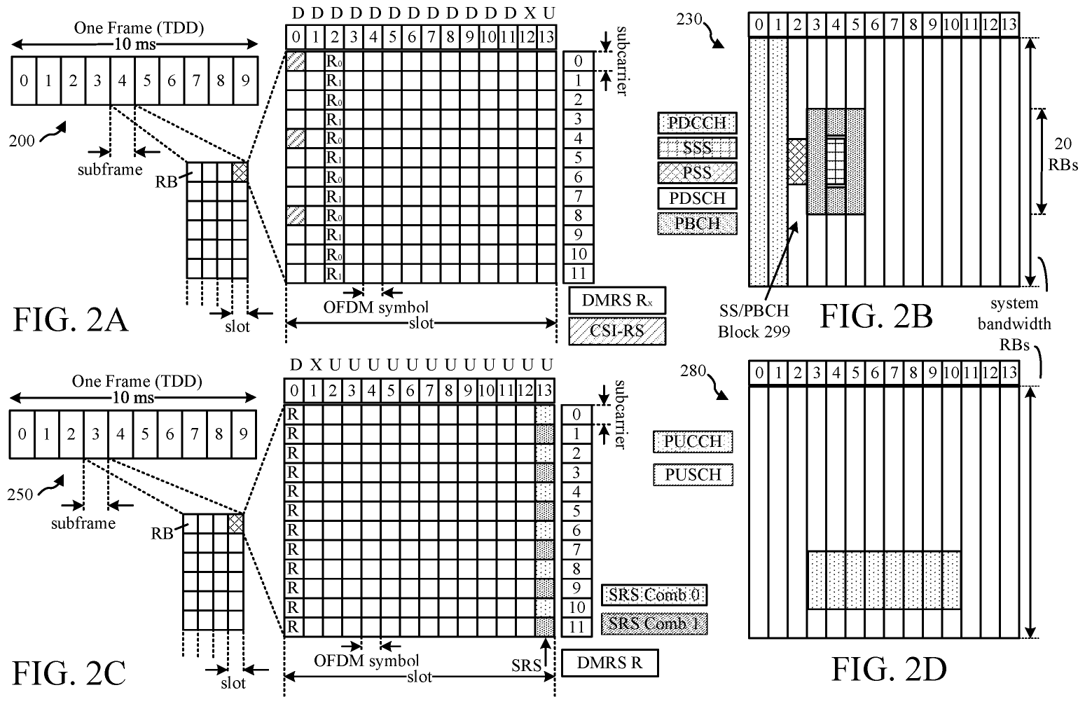

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250) illustrating an example of a second subframe within a 5G/NR frame structure. FIG. 2D is a diagram 280 illustrating an example of UL channels within a 5G/NR subframe. The 5G/NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0) to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 KHz and the numerology μ=5 has a subcarrier spacing of 480 KHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS). Some examples of the technology disclosed herein use the DM-RS of the physical downlink control channel (PDCCH) to aid in channel estimation (and eventual demodulation of the user data portions) of the physical downlink shared channel (PDSCH).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK)/negative ACK (NACK) feedback. The PUSCH carries data and may additionally be used to carry a buffer status report (BSR), a power headroom report (PHR), and/or UCI.

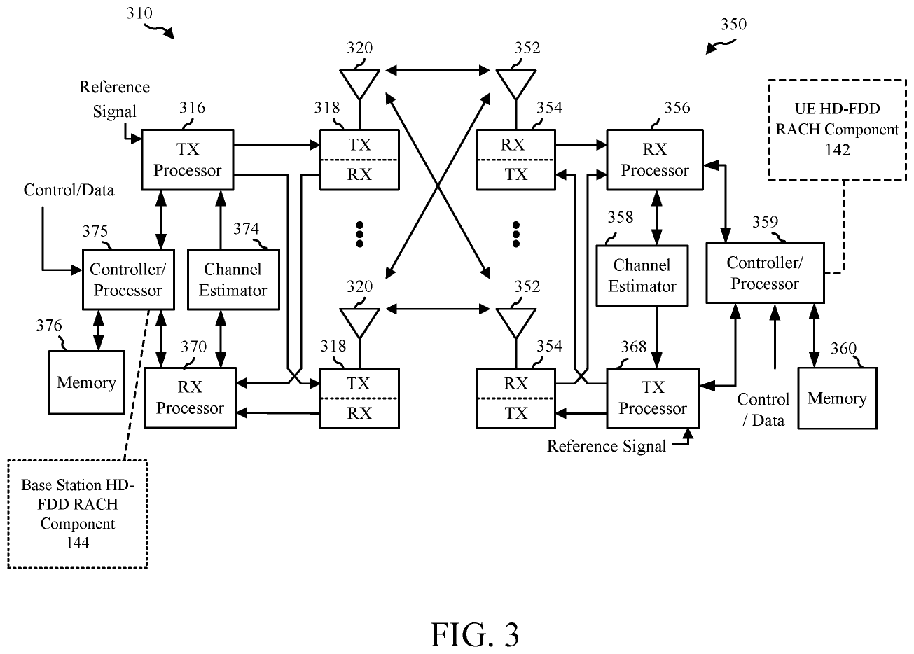

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK). M-phase-shift keying (M-PSK). M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate a radio frequency (RF) carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and de-interleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting: PDCP layer functionality associated with header compression/decompression, and security (ciphering, deciphering, integrity protection, integrity verification): RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320). Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

Continuing to refer to FIG. 3, and continuing to refer to prior figures for context, in certain aspects, in a user equipment (UE) 350 of a wireless communication network including network/base station 310, the UE 350 configured to operate in half duplex frequency division duplexing (HD-FDD) mode with the base station 310, the UE 350 configures for one or more conditions under which the UE will transmit, e.g., using TX processor 368 and TX 354, under HD-FDD mode in uplink (UL) to the network/base station 310 and not receive in downlink (DL) from the network/base station 310 during a Random Access Channel (RACH) procedure. The UE 350 determines, e.g., using controller/processor 359, whether the configured one or more conditions obtain for a particular RACH procedure. Upon determining that the configured one or more conditions obtain for the particular RACH procedure, the UE 350) transmits, e.g., using TX processor 368 and TX 354, under HD-FDD in UL during the particular RACH procedure in accordance with the configured one or more conditions.

In some examples of the technology disclosed herein, the one or more conditions include one or more of: a priority class of RACH procedure transmissions, the priority class including one or more of physical RACH (PRACH) transmissions, physical UL shared channel (PUSCH) transmissions, physical UL control channel (PUCCH) transmissions, and sounding reference signal (SRS) transmissions; and a set of one or more transmission parameters including one or more of power control parameters, coverage enhancement parameters, and beam forming parameters of the UL transmissions of the RACH procedure.

In some examples, the transmission includes at least one of a PRACH transmission, a PUSCH transmission, a PUCCH transmission, and a SRS transmission; and transmitting includes applying one or more of power control, coverage enhancement and beamforming parameters to the transmission.

In some examples, configuring includes receiving, by the UE 350, e.g., using RX processor 356 and RX 354 via antenna 352, from the network/base station 310 in DL, the one or more conditions. In some such examples, receiving the one or more conditions includes receiving the one or more conditions via one or more of: one or more radio resource control (RRC) messages, one or more system information (SI) messages, and one or more medium access control-control element (MAC-CE) messages. In some examples configuring includes pre-configuring the UE with one or more of as the one or more conditions.

In some examples pre-configuring the UE 350 with the one or more conditions includes pre-configuring a priority class and one or more transmission parameters of the RACH procedure based on one or more of handover (HO) characteristics, scheduling requests for mission critical reports, Beam Failure Recovery (BFR) characteristics, and access identities pre-defined for higher priority access classes as the one or more conditions.

In some examples, configuring includes pre-configuring the UE 350 with the one or more conditions; receiving, by the UE 350, e.g., using RX processor 356 and RX 354 via antenna 352, from the network/base station 310 in DL, one or more modifications to the pre-configured one or more conditions; and reconfiguring the UE 350 with the received one or more modifications.

In some examples, configuring includes identifying a set of one or more RACH procedure characteristics as the one or more conditions under which the UE 350 will transmit, e.g., using TX processor 368 and TX 354, under HD-FDD mode in UL and not receive in DL regardless of one or more DL transmission characteristics; and configuring the UE in accordance with the identified set of one or more RACH procedure characteristics. In some such examples, the set of one or more RACH procedure characteristics comprises one or more of: handover (HO) characteristics, scheduling requests for mission critical reports, Beam Failure Recovery (BFR) characteristics, and access identities pre-defined for higher priority access classes.

In some examples, configuring includes identifying a set of one or more DL transmission characteristics under which the UE 350 will transmit, e.g., using TX processor 368 and TX 354, during a RACH procedure under HD-FDD mode in UL 350 and not receive in DL; and configuring the UE 350 in accordance with the identified set of one or more DL transmission characteristics. In some such examples, the set of one or more DL transmission characteristics includes all semi-static and cell-specific DL transmissions. In some such examples, the set of one or more DL transmission characteristics includes all semi-static and cell-specific DL transmissions, except synchronization signal block (SSB) transmissions. In some such examples, the set of one or more DL transmission characteristics excludes certain synchronization signal block (SSB) transmissions as a function of one or more of radio resource management (RRM), beam failure detection (BFD), radio link monitoring (RLM), and time/frequency tracking requirements of the UE 350. In some such examples, the set of one or more DL transmission characteristics includes, for a given dynamic UL grant for RACH procedures, semi-static and cell-specific DL transmissions arriving at the UE after the given dynamic UL grant for RACH procedures.

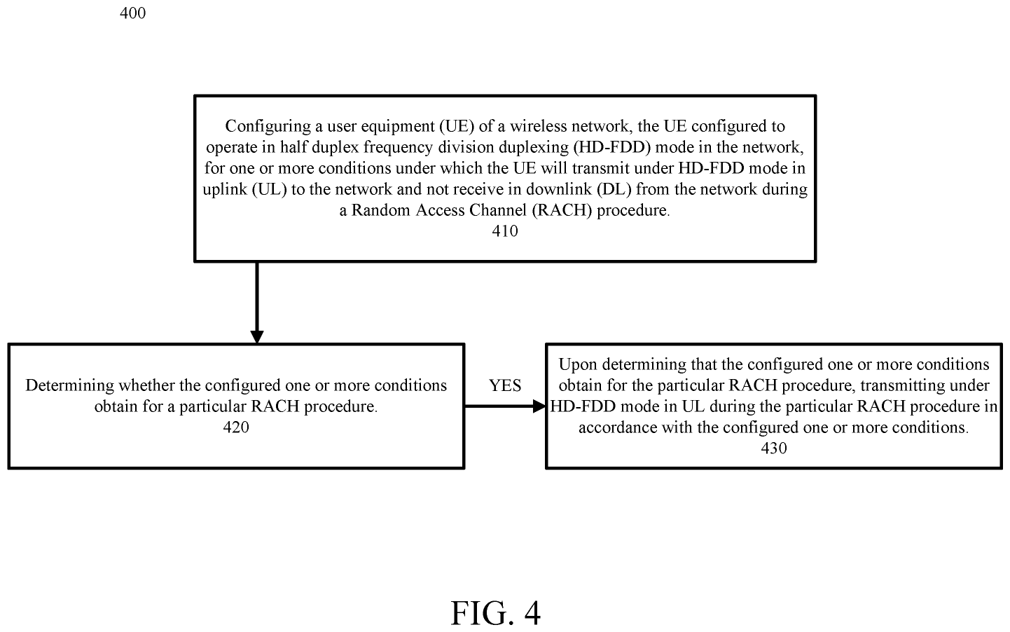

Referring to FIG. 4, and continuing to refer to prior figures for context, a flowchart of methods 400 of wireless communication is shown, in accordance with examples of the technology disclosed herein. In such methods 400, the UE 184 is configured to operate in half duplex frequency division duplexing (HD-FDD) mode in the network. In such methods 400, the UE 184 further configures itself for one or more conditions under which the UE will transmit under HD-FDD mode in uplink (UL) to the network and not receive in downlink (DL) from the network during a Random Access Channel (RACH) procedure—Block 410.

In some examples, the one or more conditions include one or more of: a priority class of RACH procedure transmissions, the priority class including one or more of physical RACH (PRACH) transmissions, physical UL shared channel (PUSCH) transmissions, physical UL control channel (PUCCH) transmissions, and sounding reference signal (SRS) transmissions; and a set of one or more transmission parameters including one or more of power control parameters, coverage enhancement parameters, and beam forming parameters of the UL transmissions of the RACH procedure.

In some examples, the transmission includes at least one of a PRACH transmission, a PUSCH transmission, a PUCCH transmission, and a SRS transmission. In such examples, transmitting includes applying one or more of power control, coverage enhancement and beamforming parameters to the transmission.

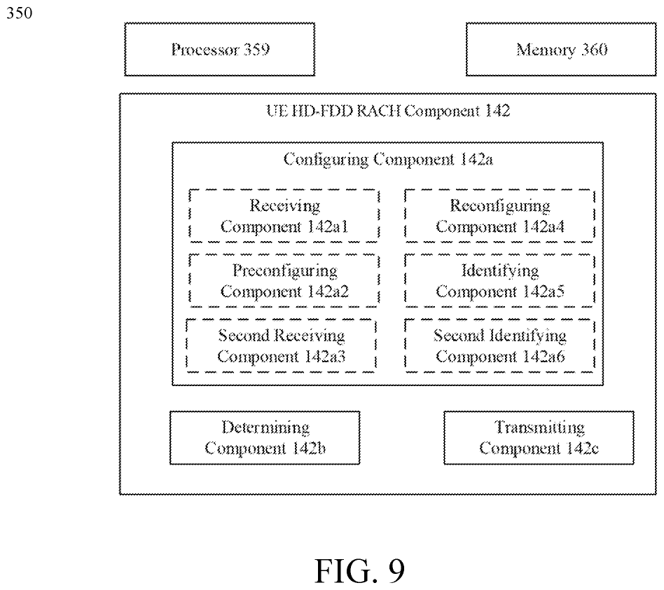

Referring to FIG. 9, and continuing to refer to prior figures for context, another representation of the UE 350 for wireless communication of FIG. 3 is shown, in accordance with examples of the technology disclosed herein. UE 350 includes UE HD-FDD RACH component 142, controller/processor 359, and memory 360, as described in conjunction with FIG. 3 above. UE HD-FDD RACH component 142 includes configuring component 142a. In some examples, the configuring component 142a configures the UE 350 for one or more conditions under which the UE 350 will transmit under HD-FDD mode in uplink (UL) to the network (e.g., a base station 310 thereof) and not receive in downlink (DL) from the network during a Random Access Channel (RACH) procedure. Accordingly, configuring component 142a may provide means for configuring the UE 350 for one or more conditions under which the UE 350 will transmit under HD-FDD mode in uplink (UL) to the network (e.g., a base station 310 thereof) and not receive in downlink (DL) from the network during a Random Access Channel (RACH) procedure.

Referring again to FIG. 4, UE 184 determines whether the configured one or more conditions obtain for a particular RACH procedure—Block 420.

Referring again to FIG. 9, UE HD-FDD RACH component 142 includes determining component 142b. In some examples, the determining component 142b determines whether the configured one or more conditions obtain for a particular RACH procedure. Accordingly, determining component 142b may provide means for determining whether the configured one or more conditions obtain for a particular RACH procedure.

Referring again to FIG. 4, upon determining that the configured one or more conditions obtain for the particular RACH procedure, UE 184 transmits under HD-FDD mode in UL during the particular RACH procedure in accordance with the configured one or more conditions—Block 430.

Referring again to FIG. 9, UE HD-FDD RACH component 142 includes transmitting component 142c. In some examples, the transmitting component 142c upon determining that the configured one or more conditions obtain for the particular RACH procedure, transmits under HD-FDD mode in UL during the particular RACH procedure in accordance with the configured one or more conditions. Accordingly, transmitting component 142c may provide means determining for transmitting, upon determining that the configured one or more conditions obtain for the particular RACH procedure, under HD-FDD mode in UL during the particular RACH procedure in accordance with the configured one or more conditions.

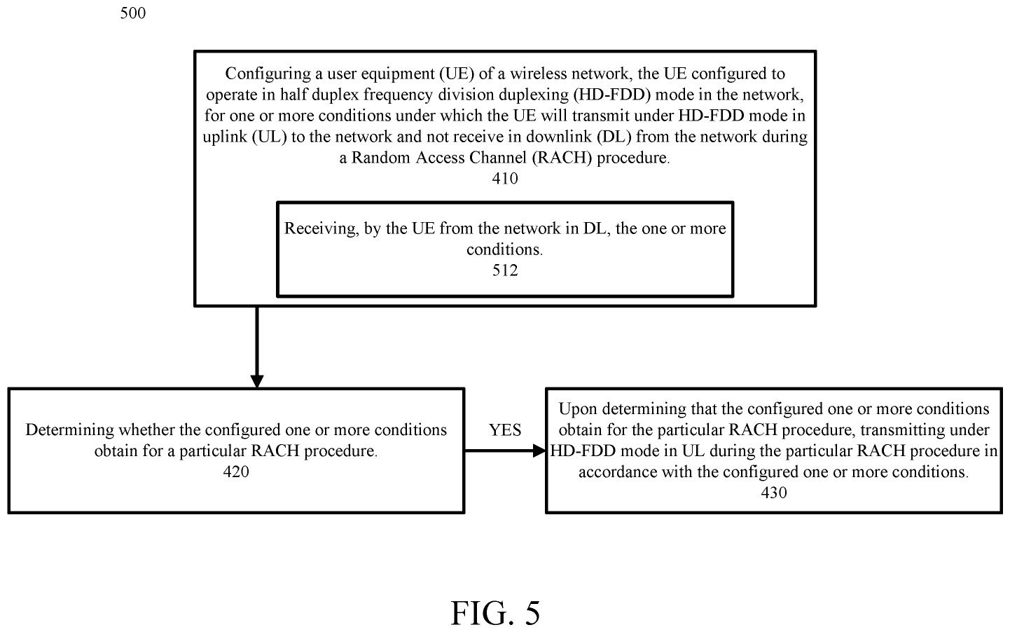

Referring to FIG. 5, and continuing to refer to prior figures for context, a flowchart of methods 500 of wireless communication is shown, in accordance with examples of the technology disclosed herein. In such methods 500, Block 420 and Block 430 are performed as described above. In such methods 500, configuring 410 includes receiving, by the UE from the network in DL, the one or more conditions—Block 512.

In some aspects, receiving the one or more conditions comprises receiving the one or more conditions via one or more of: one or more radio resource control (RRC) messages, one or more system information (SI) messages, and one or more medium access control-control element (MAC-CE) messages. In some aspects, configuring comprises pre-configuring the UE with the one or more conditions.

Referring again to FIG. 9, configuring component 142a includes receiving component 142a1. In some examples, the receiving component 142a1 receives, by the UE 184 from the network in DL, the one or more conditions. Accordingly, receiving component 142a1 may provide means for receiving, by the UE from the network in DL, the one or more conditions.

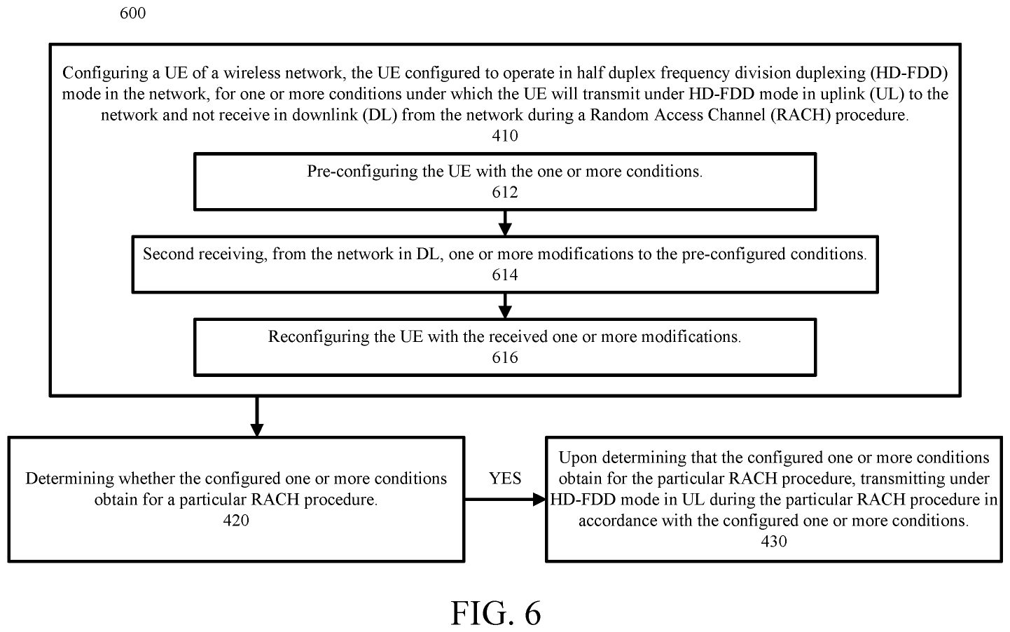

Referring to FIG. 6, and continuing to refer to prior figures for context, a flowchart of methods 600 of wireless communication is shown, in accordance with examples of the technology disclosed herein. In such methods 600, Block 420 and Block 430 are performed as described above. In such methods 600, configuring 410 includes pre-configuring the UE with the one or more conditions—Block 612.

In some examples, pre-configuring the UE with the one or more conditions includes pre-configuring a priority class and one or more transmission parameters of the RACH procedure based on one or more of handover (HO) characteristics, scheduling requests for mission critical reports, Beam Failure Recovery (BFR) characteristics, and access identities pre-defined for higher priority access classes as the one or more conditions. Each RACH attempt is associated with one access class and at least one access identity. In TS 22.261, v18.0.0, 3GPP specifies a list of access identities associated with different UE configuration, which can be configured with high or regular priority classes. For example, RACH initiated by UE configured with disaster condition services, multi-media priority services, public safety or emergency services are associated higher priority class. RACH initiated by UE configured for public utilities has regular priority class.

Referring again to FIG. 9, configuring component 142a includes pre-configuring component 142a2. In some examples, the pre-configuring component 142a2 pre-configures the UE 184 with the one or more conditions. Accordingly, pre-configuring component 142a2 may provide means for pre-configuring the UE with the one or more conditions.

Subsequent to pre-configuring, the UE 184 receives, from the network in DL, one or more modifications to the pre-configured one or more conditions—Block 614.

Referring again to FIG. 9, configuring component 142a includes second receiving component 142a3. In some examples, the second receiving component 142a3 receives, from the network in DL, one or more modifications to the pre-configured one or more conditions. Accordingly, second receiving component 142a3 may provide means for receiving, from the network in DL, one or more modifications to the pre-configured one or more conditions.

Subsequent to the second receiving, the UE 184 re-configures the UE with the received one or more modifications—Block 616.

Referring again to FIG. 9, configuring component 142a includes reconfiguring component 142a4. In some examples, the reconfiguring component 142a4 re-configures the UE with the received one or more modifications. Accordingly, reconfiguring component 142a4 may provide means for re-configuring the UE with the received one or more modifications.

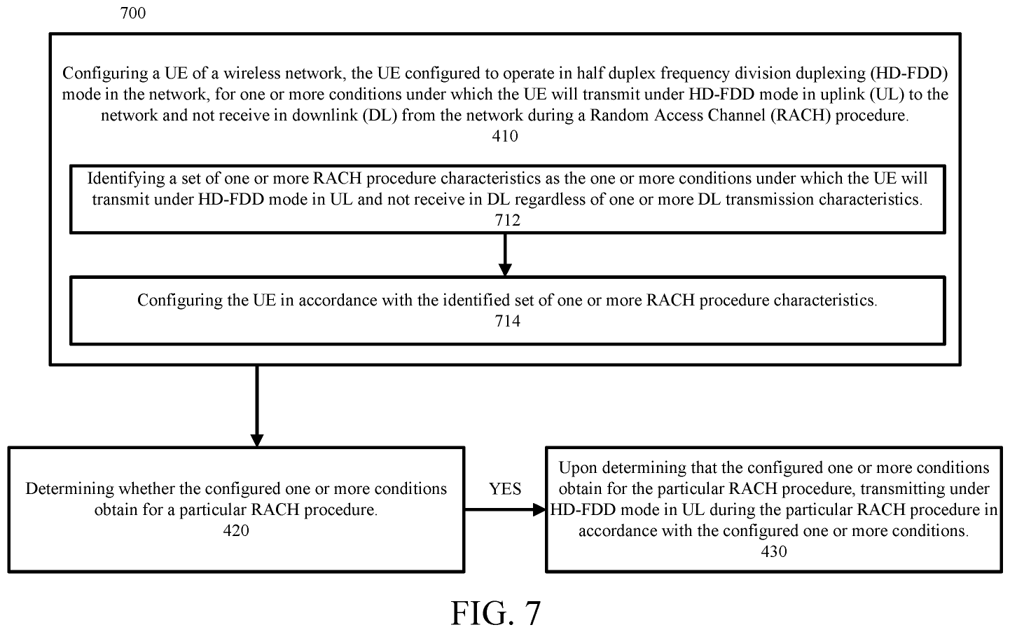

Referring to FIG. 7, and continuing to refer to prior figures for context, a flowchart of methods 700 of wireless communication is shown, in accordance with examples of the technology disclosed herein. In such methods 700, Block 420 and Block 430 are performed as described above. In such methods 700, configuring 410 includes identifying a set of one or more RACH procedure characteristics as the one or more conditions under which the UE will transmit under HD-FDD mode in UL and not receive in DL regardless of one or more DL transmission characteristics—Block 712.

In some aspects the set of one or more RACH procedure characteristics includes one or more of: handover (HO) characteristics, scheduling requests for mission critical reports, Beam Failure Recovery (BFR) characteristics, and access identities pre-defined for higher priority access classes.

Referring again to FIG. 9, configuring component 142a includes identifying component 142a5. In some examples, the identifying component 142a5 identifies a set of one or more RACH procedure characteristics as the one or more conditions under which the UE will transmit under HD-FDD mode in UL and not receive in DL regardless of one or more DL transmission characteristics. Accordingly, identifying component 142a5 may provide means for identifying a set of one or more RACH procedure characteristics as the one or more conditions under which the UE will transmit under HD-FDD mode in UL and not receive in DL regardless of one or more DL transmission characteristics.

In such methods 700, configuring 410 also includes configuring the UE in accordance with the identified set of one or more RACH procedure characteristics—Block 714.

Referring again to FIG. 9, configuring component 142a also configures the UE in accordance with the identified set of one or more RACH procedure characteristics. Accordingly, configuring component 142a also may provide means for configuring the UE in accordance with the identified set of one or more RACH procedure characteristics.

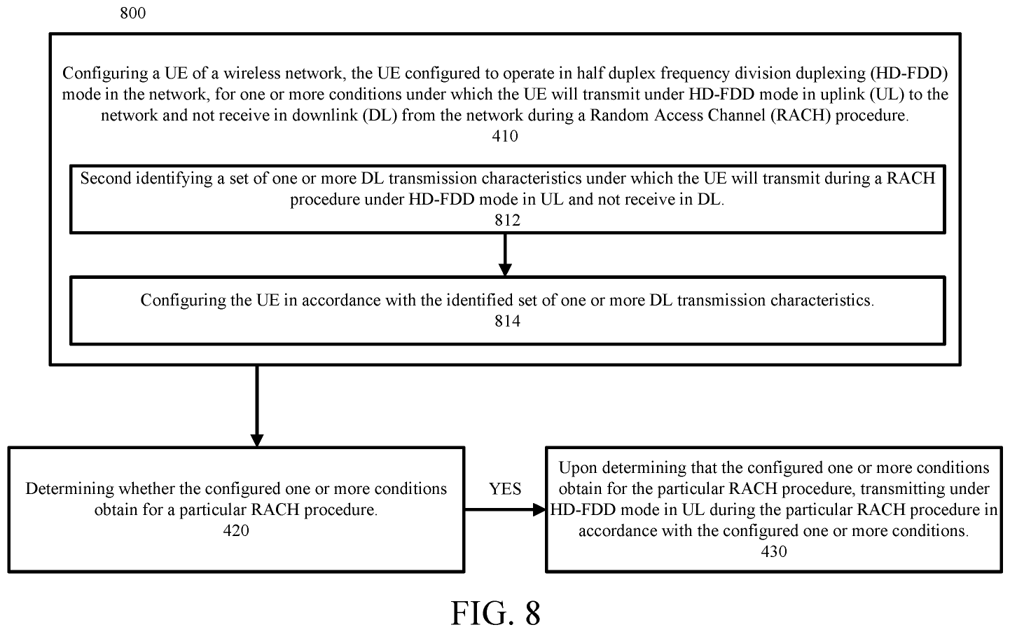

Referring to FIG. 8, and continuing to refer to prior figures for context, a flowchart of methods 800 of wireless communication is shown, in accordance with examples of the technology disclosed herein. In such methods 800, Block 420 and Block 430 are performed as described above. In such methods 800, configuring 410 includes identifying a set of one or more DL transmission characteristics under which the UE will transmit during a RACH procedure under HD-FDD mode in UL and not receive in DL—Block 812.

In some aspects, the set of one or more DL transmission characteristics comprises all semi-static and cell-specific DL transmissions. In some aspects, the set of one or more DL transmission characteristics comprises all semi-static and cell-specific DL transmissions, except synchronization signal block (SSB) DL transmissions. In some aspects, the set of one or more DL transmission characteristics excludes certain synchronization signal block (SSB) transmissions as a function of one or more of radio resource management (RRM), beam failure detection (BFD), radio link monitoring (RLM), and time/frequency tracking requirements of the UE. In some aspects, the set of one or more DL transmission characteristics comprises, for a given dynamic UL grant for RACH procedures, semi-static and cell-specific DL transmissions arriving at the UE after the given dynamic UL grant for RACH procedures.

Referring again to FIG. 9, configuring component 142a includes second identifying component 142a6. In some examples, the second identifying component 142a6 identifies a set of one or more DL transmission characteristics under which the UE will transmit during a RACH procedure under HD-FDD mode in UL and not receive in DL. Accordingly, second identifying component 142a6 may provide means for identifying a set of one or more DL transmission characteristics under which the UE will transmit during a RACH procedure under HD-FDD mode in UL and not receive in DL.

In such methods 800, configuring 410 also includes configuring the UE in accordance with the identified set of one or more DL transmission characteristics—Block 814.

Referring again to FIG. 9, configuring component 142a also configures the UE in accordance with the identified set of one or more DL transmission characteristics. Accordingly, configuring component 142a also may provide means for configuring the UE in accordance with the identified set of one or more DL transmission characteristics.

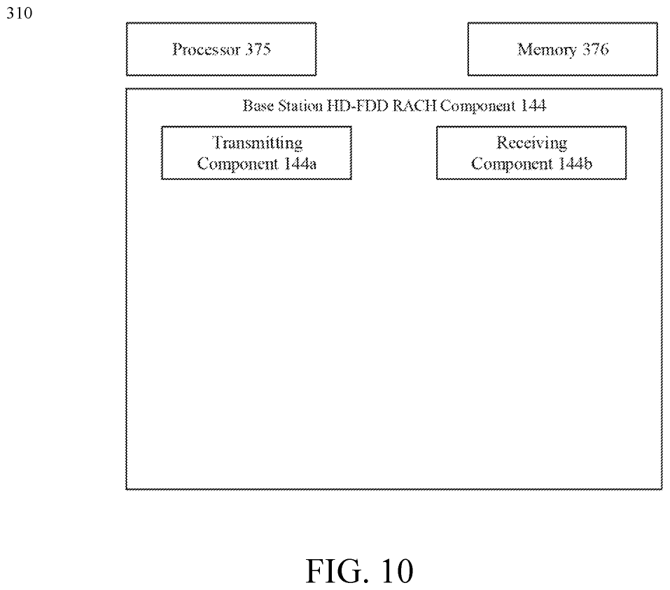

Referring to FIG. 10, and continuing to refer to prior figures for context, a flowchart of methods 1000 of wireless communication is shown, in accordance with examples of the technology disclosed herein. In such methods 1000, the base station (as part of the network) transmits, to a user equipment (UE) of the network, a configuration in which the UE can transmit under half duplex frequency division duplexing (HD-FDD) mode in uplink (UL) to the network, and not receive in downlink (DL) from the network, during a Random Access Channel (RACH) procedure—Block 1010.

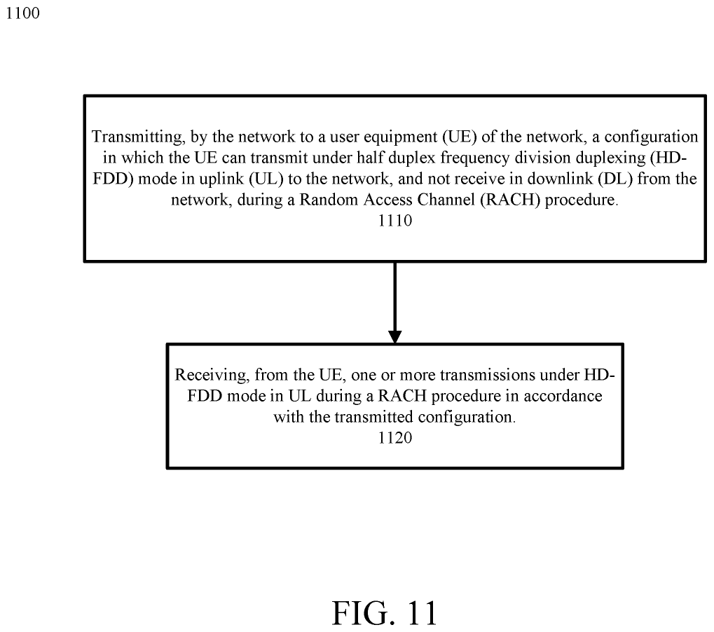

Referring to FIG. 11, and continuing to refer to prior figures for context, another representation of the base station 310 for wireless communication of FIG. 3 is shown, in accordance with examples of the technology disclosed herein. Base station 310 includes Base Station HD-FDD RACH component 144, controller/processor 375, and memory 376, as described in conjunction with FIG. 3 above. Base Station HD-FDD RACH component 144 includes transmitting component 144a. In some examples, the transmitting component 144a transmits, to a user equipment (UE) of the network, a configuration in which the UE can transmit under half duplex frequency division duplexing (HD-FDD) mode in uplink (UL) to the network, and not receive in downlink (DL) from the network, during a Random Access Channel (RACH) procedure. Accordingly, transmitting component 144a may provide means for transmitting, to a user equipment (UE) of the network, a configuration in which the UE can transmit under half duplex frequency division duplexing (HD-FDD) mode in uplink (UL) to the network, and not receive in downlink (DL) from the network, during a Random Access Channel (RACH) procedure.

Referring again to FIG. 10, base station 310 receives, from the UE, one or more transmissions under HD-FDD mode in UL during a RACH procedure in accordance with the transmitted configuration—Block 420.

Referring again to FIG. 9, Base Station HD-FDD RACH component 144 includes receiving component 144b. In some examples, the receiving component 144b receives, from the UE, one or more transmissions under HD-FDD mode in UL during a RACH procedure in accordance with the transmitted configuration. Accordingly, receiving component 144b may provide means for receiving, from the UE, one or more transmissions under HD-FDD mode in UL during a RACH procedure in accordance with the transmitted configuration.

The following examples are illustrative only and aspects thereof may be combined with aspects of other embodiments or teaching described herein, without limitation.

Example 1 is method of wireless communication, including in a user equipment (UE) of a wireless communication network, the UE configured to operate in half duplex frequency division duplexing (HD-FDD) mode in the network the UE configures for one or more conditions under which the UE will transmit under HD-FDD mode in uplink (UL) to the network and not receive in downlink (DL) from the network during a Random Access Channel (RACH) procedure. The UE determines whether the configured one or more conditions obtain for a particular RACH procedure. Upon determining that the configured one or more conditions obtain for the particular RACH procedure, the UE transmits under HD-FDD in UL during the particular RACH procedure in accordance with the configured one or more conditions. In some examples of the technology disclosed herein, the one or more conditions include one or more of: a priority class of RACH procedure transmissions, the priority class including one or more of physical RACH (PRACH) transmissions, physical UL shared channel (PUSCH) transmissions, physical UL control channel (PUCCH) transmissions, and sounding reference signal (SRS) transmissions; and a set of one or more transmission parameters including one or more of power control parameters, coverage enhancement parameters, and beam forming parameters of the UL transmissions of the RACH procedure.

In some examples, the transmission includes at least one of a PRACH transmission, a PUSCH transmission, a PUCCH transmission, and a SRS transmission; and transmitting includes applying one or more of power control, coverage enhancement and beamforming parameters to the transmission.

Example 2 includes the Example 1, wherein configuring includes receiving, by the UE from the network in DL, the one or more conditions. In some such examples, receiving the one or more conditions includes receiving the one or more conditions via one or more of: one or more radio resource control (RRC) messages, one or more system information (SI) messages, and one or more medium access control-control element (MAC-CE) messages. Example 3 includes either of Example 1 and Example 2, wherein configuring includes pre-configuring the UE with the one or more conditions.

Example 4 includes any of Example 1-Example 3, wherein pre-configuring the UE with the one or more conditions includes pre-configuring a priority class and one or more transmission parameters of the RACH procedure based on one or more of handover (HO) characteristics, scheduling requests for mission critical reports, Beam Failure Recovery (BFR) characteristics, and access identities pre-defined for higher priority access classes as the one or more conditions.

Example 5 includes any of Example 1-Example 4, wherein configuring includes pre-configuring the UE with the one or more conditions: receiving, by the UE from the network in DL, one or more modifications to the pre-configured one or more conditions; and reconfiguring the UE with the received one or more modifications. Example 6 includes any of Example 1-Example 5, wherein the set of one or more RACH procedure characteristics includes one or more of: handover (HO) characteristics, Beam Failure Recovery (BFR) characteristics, access identities pre-defined for higher priority access classes.

Example 7 includes any of Example 1-Example 6, wherein configuring includes identifying a set of one or more RACH procedure characteristics as the one or more conditions under which the UE will transmit under HD-FDD mode in UL and not receive in DL regardless of one or more DL transmission characteristics; and configuring the UE in accordance with the identified set of one or more RACH procedure characteristics. Example 8 includes any of Example 1-Example 7, wherein the set of one or more DL transmission characteristics comprises all semi-static and cell-specific DL transmissions. Example 9 includes any of Example 1-Example 8, wherein the set of one or more DL transmission characteristics comprises all semi-static and cell-specific DL transmissions, except synchronization signal block (SSB) DL transmissions. Example 10 includes any of Example 1-Example 9, wherein the set of one or more DL transmission characteristics excludes certain synchronization signal block (SSB) DL transmissions as a function of one or more of radio resource management (RRM), radio link monitoring (RLM), and tracking requirements of the UE. Example 11 includes any of Example 1-Example 10, wherein the set of one or more DL transmission characteristics comprises, for a given dynamic UL grant for RACH procedures, semi-static and cell-specific DL transmissions arriving at the UE after the given dynamic UL grant for RACH procedures.

Example 12 includes an apparatus for wireless communication, comprising: a memory; and at least one processor coupled to the memory and configured to execute the method of any one or more of examples 1-11. Example 13 includes a computer-readable medium storing computer executable code, the code when executed by a processor cause the processor to execute the method of any one or more of claims 1-11. Example 14 includes an apparatus for wireless communications, including means for executing the method of any one or more of claims 1-11.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

We claim:

1. A wireless communication method in a user equipment (UE) of a wireless communication network, the UE configured to operate in half duplex frequency division duplexing (1-ID-FDD) mode in the network, the method comprising:
configuring the UE for one or more conditions under which the UE will transmit under HD-FDD mode in uplink (UL) to a network device of the network and not receive in downlink (DL) from the network device during a Random Access Channel (RACH) procedure;
determining whether the configured one or more conditions arise for a particular RACH procedure; and
upon determining that the configured one or more conditions arise for the particular RACH procedure, transmitting under HD-FDD mode in UL during the particular RACH procedure in accordance with the configured one or more conditions.

2. The method of claim 1 wherein the one or more conditions include one or more of:
a priority class of RACH procedure transmissions, the priority class including one or more of physical RACH (PRACH) transmissions, physical UL shared channel (PUSCH) transmissions, physical UL control channel (PUCCH) transmissions, and sounding reference signal (SRS) transmissions; and
a set of one or more transmission parameters including one or more of power control parameters, coverage enhancement parameters, and beam forming parameters of the UL transmissions of the RACH procedure.

3. The method of claim 2, wherein:
a transmission associated with the particular RACH procedure comprises at least one of a PRACH transmission, a PUSCH transmission, a PUCCH transmission, and a SRS transmission; and
transmitting comprises applying one or more of power control, coverage enhancement and beamforming parameters to the transmission.

4. The method of claim 1, wherein configuring comprises receiving, by the UE from the network device in DL, the one or more conditions.

5. The method of claim 4, wherein receiving the one or more conditions comprises receiving the one or more conditions via one or more of: one or more radio resource control (RRC) messages, one or more system information (SI) messages, and one or more medium access control-control element (MAC-CE) messages.

6. The method of claim 1, wherein configuring comprises pre-configuring the UE with one or more of as the one or more conditions.

7. The method of claim 6, wherein pre-configuring the UE with the one or more conditions comprises pre-configuring a priority class and one or more transmission parameters of the RACH procedure based on one or more of handover (HO) characteristics, scheduling requests for mission critical reports, Beam Failure Recovery (BFR) characteristics, and access identities pre-defined for higher priority access classes as the one or more conditions.

8. The method of claim 1, wherein configuring comprises: pre-configuring the UE with the one or more conditions:
receiving, by the UE from the network device in DL, one or more modifications to the pre-configured one or more conditions; and
reconfiguring the UE with the received one or more modifications.

9. The method of claim 1, wherein configuring comprises:
identifying a set of one or more RACH procedure characteristics as the one or more conditions under which the UE will transmit under HD-FDD mode in UL and not receive in DL regardless of one or more DL transmission characteristics; and
configuring the UE in accordance with the identified set of one or more RACH procedure characteristics.

10. The method of claim 9, wherein the set of one or more RACH procedure characteristics comprises one or more of: handover (HO) characteristics, scheduling requests for mission critical reports, Beam Failure Recovery (BFR) characteristics, and access identities pre-defined for higher priority access classes.

11. The method of claim 1, wherein configuring comprises:
identifying a set of one or more DL transmission characteristics under which the UE will transmit during a RACH procedure under HD-FDD mode in UL and not receive in DL; and
configuring the UE m accordance with the identified set of one or more DL transmission characteristics.

12. The method of claim 11, wherein the set of one or more DL transmission characteristics comprises semi-static and cell-specific DL transmissions.

13. The method of claim 11, wherein the set of one or more DL transmission characteristics comprises semi-static and cell-specific DL transmissions, except synchronization signal block (SSB) transmissions.

14. The method of claim 11, wherein the set of one or more DL transmission characteristics excludes certain synchronization signal block (SSB) transmissions as a function of one or more of radio resource management (RRM), beam failure detection (BFD), radio link monitoring (RLM), and time/frequency tracking requirements of the UE.

15. The method of claim 11, wherein the set of one or more DL transmission characteristics comprises, for a given dynamic UL grant for RACH procedures, semi-static and cell-specific DL transmissions arriving at the UE after the given dynamic UL grant for RACH procedures.

16. A wireless communication method, comprising:
transmitting, by a network device to a user equipment (UE), a configuration in which the UE can transmit under half duplex frequency division duplexing (HD-FDD) mode in uplink (UL) to the network device, and not receive in downlink (DL) from the network device, during a Random Access Channel (RACH) procedure; and
receiving, from the UE, one or more transmissions under HD-FDD mode in UL during a RACH procedure in accordance with the transmitted configuration.

17. A user equipment (UE) for wireless communication, the UE configured to operate in half duplex frequency division duplexing (IID-FDD) mode and comprising:
a memory; and
at least one processor coupled to the memory, the memory including instructions for the at least one processor to cause the UE to:
configure the UE for one or more conditions under which the UE will transmit under HD-FDD mode in uplink (UL) to a network device and not receive in downlink (DL) from the network device during a Random Access Channel (RACH) procedure;
determine whether the configured one or more conditions arise for a particular RACH procedure; and
upon determining that the configured one or more conditions arise for the particular RACH procedure, transmit under HD-FDD mode in UL during the particular RACH procedure in accordance with the configured one or more conditions.

18. The UE of claim 17, wherein the one or more conditions include one or more of:
a priority class of RACH procedure transmissions, the priority class including one or more of physical RACH (PRACH) transmissions, physical UL shared channel (PUSCH) transmissions, physical UL control channel (PUCCH) transmissions, and sounding reference signal (SRS) transmissions; and
a set of one or more transmission parameters including one or more of power control parameters, coverage enhancement parameters, and beam forming parameters of the UL transmissions of the RACH procedure.

19. The UE of claim 18, wherein:
a transmission associated with the particular RACH procedure comprises at least one of a PRACH transmission, a PUSCH transmission, a PUCCH transmission, and a SRS transmission; and
transmitting comprises applying one or more of power control, coverage enhancement and beamforming parameters to the transmission.

20. The UE of claim 17, wherein configuring comprises receiving, by the UE from the network device in DL, the one or more conditions.

21. The UE of claim 20, wherein receiving the one or more conditions comprises receiving the one or more conditions via one or more of: one or more radio resource control (RRC) messages, one or more system information (SI) messages, and one or more medium access control-control element (MAC-CE) messages.

22. The UE of claim 17, wherein configuring comprises pre-configuring the UE with one or more of as the one or more conditions.

23. The UE of claim 22, wherein pre-configuring the UE with the one or more conditions comprises pre-configuring a priority class and one or more transmission parameters of the RACH procedure based on one or more of handover (HO) characteristics, scheduling requests for mission critical reports, Beam Failure Recovery (BFR) characteristics, and access identities pre-defined for higher priority access classes as the one or more conditions.

24. The UE of claim 17, wherein configuring comprises:
pre-configuring the UE with the one or more conditions;
receiving, by the UE from the network device in DL, one or more modifications to the pre-configured one or more conditions; and
reconfiguring the UE with the received one or more modifications.

25. The UE of claim 17, wherein configuring comprises:
identifying a set of one or more RACH procedure characteristics as the one or more conditions under which the UE will transmit under 1-ID-FDD mode in UL and not receive in DL regardless of one or more DL transmission characteristics; and
configuring the UE in accordance with the identified set of one or more RACH procedure characteristics.

26. The UE of claim 25, wherein the set of one or more RACH procedure characteristics comprises one or more of: handover (HO) characteristics, scheduling requests for mission critical reports, Beam Failure Recovery (BFR) characteristics, and access identities pre-defined for higher priority access classes.

27. The UE of claim 17, wherein configuring comprises:
identifying a set of one or more DL transmission characteristics under which the UE will transmit during a RACH procedure under 1-ID-FDD mode in UL and not receive in DL; and
configuring the UE in accordance with the identified set of one or more DL transmission characteristics.

28. The UE of claim 27, wherein the set of one or more DL transmission characteristics comprises semi-static and cell-specific DL transmissions.

29. The UE of claim 27, wherein the set of one or more DL transmission characteristics comprises semi-static and cell-specific DL transmissions, except synchronization signal block (SSB) DL transmissions.

30. The UE of claim 27, wherein the set of one or more DL transmission characteristics excludes certain synchronization signal block (SSB) transmissions as a function of one or more of radio resource management (RRM), beam failure detection (BFD), radio link monitoring (RLM), and time/frequency tracking requirements of the UE.

31. The UE of claim 27, wherein the set of one or more DL transmission characteristics comprises, for a given dynamic UL grant for RACH procedures, semi-static and cell-specific DL transmissions arriving at the UE after the given dynamic UL grant for RACH procedures.

32. An apparatus for wireless communication method, comprising:
a memory; and
at least one processor coupled to the memory, the memory including instructions for the at least one processor to cause the apparatus to:
transmit, by the apparatus to a user equipment (UE), a configuration in which the UE can transmit under half duplex frequency division duplexing (HD-FDD) mode in uplink (UL) to the apparatus, and not receive in downlink (DL) from the apparatus, during a Random Access Channel (RACH) procedure; and
receive, from the UE, one or more transmissions under HD-FDD mode in UL during a RACH procedure in accordance with the transmitted configuration.

33. A computer-readable medium storing computer executable code, the code for causing at least one processor of a user equipment (UE) configured to operate in half duplex frequency division duplexing (HD-FDD) mode to:
configure a UE for one or more conditions under which the UE will transmit under HD-FDD mode in uplink (UL) to a network device and not receive in downlink (DL) from the network device during a Random Access Channel (RACH) procedure;
determine whether the configured one or more conditions arise for a particular RACH procedure; and
upon determining that the configured one or more conditions arise for the particular RACH procedure, transmit under HD-FDD mode in UL during the particular RACH procedure in accordance with the configured one or more conditions.

34. The computer-readable medium of claim 33, wherein the one or more conditions include one or more of:
a priority class of RACH procedure transmissions, the priority class including one or more of physical RACH (PRACH) transmissions, physical UL shared channel (PUSCH) transmissions, physical UL control channel (PUCCH) transmissions, and sounding reference signal (SRS) transmissions; and
a set of one or more transmission parameters including one or more of power control parameters, coverage enhancement parameters, and beam forming parameters of the UL transmissions of the RACH procedure.

35. The computer-readable medium of claim 34, wherein:
a transmission associated with the particular RACH procedure comprises at least one of a PRACH transmission, a PUSCH transmission, a PUCCH transmission, and a SRS transmission; and
transmitting comprises applying one or more of power control, coverage enhancement and beamforming parameters to the transmission.

36. The computer-readable medium of claim 33, wherein configuring comprises receiving, by the UE from the network device in DL, the one or more conditions.

37. The computer-readable medium of claim 36, wherein receiving the one or more conditions comprises receiving the one or more conditions via one or more of: one or more radio resource control (RRC) messages, one or more system information (SI) messages, and one or more medium access control-control element (MAC-CE) messages.

38. The computer-readable medium of claim 33, wherein configuring comprises pre-configuring the UE with one or more of as the one or more conditions.

39. The computer-readable medium of claim 38, wherein pre-configuring the UE with the one or more conditions comprises pre-configuring a priority class and one or more transmission parameters of the RACH procedure based on one or more of handover (HO) characteristics, scheduling requests for mission critical reports, Beam Failure Recovery (BFR) characteristics, and access identities pre-defined for higher priority access classes as the one or more conditions.

40. The computer-readable medium of claim 33, wherein configuring comprises:
pre-configuring the UE with the one or more conditions;
receiving, by the UE from the network device in DL, one or more modifications to the pre-configured one or more conditions; and
reconfiguring the UE with the received one or more modifications.

41. The computer-readable medium of claim 33, wherein configuring comprises:
identifying a set of one or more RACH procedure characteristics as the one or more conditions under which the UE will transmit under HD-FDD mode in UL and not receive in DL regardless of one or more DL transmission characteristics; and
configuring the UE in accordance with the identified set of one or more RACH procedure characteristics.

42. The computer-readable medium of claim 41, wherein the set of one or more RACH procedure characteristics comprises one or more of: handover (HO) characteristics, scheduling requests for mission critical reports, Beam Failure Recovery (BFR) characteristics, and access identities pre-defined for higher priority access classes.

43. The computer-readable medium of claim 33, wherein configuring comprises:
identifying a set of one or more DL transmission characteristics under which the UE will transmit during a RACH procedure under HD-FDD mode in UL and not receive in DL; and
configuring the UE m accordance with the identified set of one or more DL transmission characteristics.

44. The computer-readable medium of claim 43, wherein the set of one or more DL transmission characteristics comprises semi-static and cell-specific DL transmissions.

45. The computer-readable medium of claim 43, wherein the set of one or more DL transmission characteristics comprises semi-static and cell-specific DL transmissions, except synchronization signal block (SSB) DL transmissions.

46. The computer-readable medium of claim 43, wherein the set of one or more DL transmission characteristics excludes certain synchronization signal block (SSB) transmissions as a function of one or more of radio resource management (RRM), beam failure detection (BFD), radio link monitoring (RLM), and time/frequency tracking requirements of the UE.

47. The computer-readable medium of claim 43, wherein the set of one or more DL transmission characteristics comprises, for a given dynamic UL grant for RACH procedures, semi-static and cell-specific DL transmissions arriving at the UE after the given dynamic UL grant for RACH procedures.

48. A computer-readable medium storing computer executable code, the code for causing at least one processor to:
transmit, by a network device to a user equipment (UE), a configuration in which the UE can transmit under half duplex frequency division duplexing (HD-FDD) mode in uplink (UL) to the network device, and not receive in downlink (DL) from the network device, during a Random Access Channel (RACH) procedure; and
receive, by the network device from the UE, one or more transmissions under HD-FDD mode in UL during a RACH procedure in accordance with the transmitted configuration.

49. An apparatus for wireless communications, comprising:
means for configuring the apparatus for one or more conditions under which the apparatus will transmit under HD-FDD mode in uplink (UL) to a network device and not receive in downlink (DL) from the network device during a Random Access Channel (RACH) procedure;
means for determining whether the configured one or more conditions arise for a particular RACH procedure; and
means for transmitting, upon determining that the configured one or more conditions arise for the particular RACH procedure, under HD-FDD mode in UL during the particular RACH procedure in accordance with the configured one or more conditions.

50. The apparatus of claim 49, wherein the one or more conditions include one or more of:
a priority class of RACH procedure transmissions, the priority class including one or more of physical RACH (PRACH) transmissions, physical UL shared channel (PUSCH) transmissions, physical UL control channel (PUCCH) transmissions, and sounding reference signal (SRS) transmissions; and
a set of one or more transmission parameters including one or more of power control parameters, coverage enhancement parameters, and beam forming parameters of the UL transmissions of the RACH procedure.

51. The apparatus of claim 50, wherein:
a transmission associated with the particular RACH procedure comprises at least one of a PRACH transmission, a PUSCH transmission, a PUCCH transmission, and a SRS transmission; and
means for transmitting comprises means for applying one or more of power control, coverage enhancement and beamforming parameters to the transmission.

52. The apparatus of claim 49, wherein means for configuring comprises means for receiving, by the apparatus from the network device in DL, the one or more conditions.

53. The apparatus of claim 52, wherein means for receiving the one or more conditions comprises means for receiving the one or more conditions via one or more of: one or more radio resource control (RRC) messages, one or more system information (SI) messages, and one or more medium access control-control element (MAC-CE) messages.

54. The apparatus of claim 49, wherein means for configuring comprises means for pre-configuring the apparatus with one or more of as the one or more conditions.

55. The apparatus of claim 54, wherein means for pre-configuring the apparatus with the one or more conditions comprises means for pre-configuring a priority class and one or more transmission parameters of the RACH procedure based on one or more of handover (HO) characteristics, scheduling requests for mission critical reports, Beam Failure Recovery (BFR) characteristics, and access identities pre-defined for higher priority access classes as the one or more conditions.

56. The apparatus of claim 49, wherein means for configuring comprises:
means for pre-configuring the apparatus with the one or more conditions;
means for receiving, by the apparatus from the network device in DL, one or more modifications to the pre-configured one or more conditions; and
means for reconfiguring the apparatus with the received one or more modifications.

57. The apparatus of claim 49, wherein means for configuring comprises:
means for identifying a set of one or more RACH procedure characteristics as the one or more conditions under which the apparatus will transmit under JID-FDD mode in UL and not receive in DL regardless of one or more DL transmission characteristics; and
means for configuring the apparatus in accordance with the identified set of one or more RACH procedure characteristics.

58. The apparatus of claim 57, wherein the set of one or more RACH procedure characteristics comprises one or more of: handover (HO) characteristics, scheduling requests for mission critical reports, Beam Failure Recovery (BFR) characteristics, and access identities pre-defined for higher priority access classes.

59. The apparatus of claim 49, wherein means for configuring comprises:
means for identifying a set of one or more DL transmission characteristics under which the apparatus will transmit during a RACH procedure under HD-FDD mode in UL and not receive in DL; and
means for configuring the apparatus in accordance with the identified set of one or more DL transmission characteristics.

60. The apparatus of claim 59, wherein the set of one or more DL transmission characteristics comprises semi-static and cell-specific DL transmissions.

61. The apparatus of claim 59, wherein the set of one or more DL transmission characteristics comprises semi-static and cell-specific DL transmissions, except synchronization signal block (SSB) DL transmissions.

62. The apparatus of claim 59, wherein the set of one or more DL transmission characteristics excludes certain synchronization signal block (SSB) transmissions as a function of one or more of radio resource management (RRM), beam failure detection (BFD), radio link monitoring (RLM), and time/frequency tracking requirements of the apparatus.

63. The apparatus of claim 59, wherein the set of one or more DL transmission characteristics comprises, for a given dynamic UL grant for RACH procedures, semi-static and cell-specific DL transmissions arriving at the apparatus after the given dynamic UL grant for RACH procedures.

64. An apparatus for wireless communications, comprising:
means for transmitting, by the apparatus to a user equipment (UE), a configuration in which the UE can transmit under half duplex frequency division duplexing (HD-FDD) mode in uplink (UL) to a network device, and not receive in downlink (DL) from the network device, during a Random Access Channel (RACH) procedure; and
means for receiving, from the UE, one or more transmissions under HD-FDD mode in UL during a RACH procedure in accordance with the transmitted configuration.

65. The method of claim 1, wherein configuring the UE for one or more conditions under which the UE will transmit under HD-FDD mode in UL to the network device and not receive in downlink DL from the network device during a RACH procedure comprises configuring the UE to prioritize i) synchronization signal block (SSB) or ii) physical RACH (PRACH) or msgA physical uplink shared channel (PUSCH) triggered by higher layers.

66. The UE of claim 17, wherein configuring the UE for one or more conditions under which the UE will transmit under HD-FDD mode in UL to the network device and not receive in downlink DL from the network device during a RACH procedure comprises configuring the UE to prioritize i) synchronization signal block (SSB) or ii) physical RACH (PRACH) or msgA physical uplink shared channel (PUSCH) triggered by higher layers.

67. The computer-readable medium of claim 33, wherein configuring the UE for one or more conditions under which the UE will transmit under HD-FDD mode in UL to the network device and not receive in downlink DL from the network device during a RACH procedure comprises configuring the UE to prioritize i) synchronization signal block (SSB) or ii) physical RACH (PRACH) or msgA physical uplink shared channel (PUSCH) triggered by higher layers.

68. The apparatus of claim 49, wherein configuring the apparatus for one or more conditions under which the apparatus will transmit under HD-FDD mode in UL to the network device and not receive in downlink DL from the network device during a RACH procedure comprises configuring the apparatus to prioritize i) synchronization signal block (SSB) or ii) physical RACH (PRACH) or msgA physical uplink shared channel (PUSCH) triggered by higher layers.
